(19) United States
(12) Patent Application Publication
(10) Pub. No.: US 2005/0289537 A1
(43) Pub. Date: Dec. 29, 2005

(54) System and method for installing software on a computing device

(76) Inventor: Sam Jung-Won Lee, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/879,886

(22) Filed: Jun. 29, 2004

(51) Int. Cl. G06F 9/445

(52) U.S. Cl. 717/174

(57) ABSTRACT

In one embodiment, a method and system for installing software on a computing device includes determining during booting of the computing device whether a compressed file containing software to be installed has been stored on the computing device and, if so, calling a file installation tool that is configured to open the compressed file and install the contents of the file on the computing device.

### BACKGROUND

Various devices are now available that have processing and storage capabilities that are analogous to that of a conventional computer, such as a personal computer (PC). For example, handheld devices, such as personal digital assistants (PDAs) and mobile telephones, as well as terminal computers have computing capabilities and functionalities similar to those of PCs. Such devices often use operating systems that comprise smaller-scale versions of those used on PCs. For example, several devices use the Windows CE™ operating system, which may be described as a scaled-down version of the Windows™ operating system used on many PCs.

There are various methods available for installing software on computing devices such as those described above. For example, the various software to be installed can be packaged within a self-extracting file that installs the device operating system as well as the various programs that are packaged with the operating system. In the case of the Windows CE™ operating environment, the software can be packaged within an NK.bin file that includes an image of the operating system and that is used during the initial boot to initialize the operating system and define the environment in which it executes.

Although all of the software that is to be installed on the computing device can be contained within the self-extracting file, it may be desirable in some situations to segregate some of that software so that it exists outside of the self-extracting file and, once installed, outside of the operating system. For instance, if all of that software is contained within the self-extracting file, no programs that are installed through the extraction process can be deleted, for example to create space for other programs that the user may wish to install.

In cases in which software is to be installed on a computing device is not contained within a self-extracting file, it may be desirable to wrap that software within a separate compressed file. More specifically, it may be desirable to wrap the software within a compressed file of a well-known format given that third-party developers will be more likely to develop software for the computing device when a well-known format is available for installing software on the device. One such well- known format is the .CAB (or “cabinet”) format, which is a proprietary file format of the Microsoft Corporation.

Despite the advantages that are available by providing software to be installed within a separate compressed file, hurdles may still exist to installation of that software. For example, in the case of a proprietary file format, a special program of the creator of the proprietary file format may be required to install the software. For instance, WCELOAD.EXE of the Microsoft Corporation may be required to install files wrapped within a .CAB file on a computing device that uses the Windows CE™ operating system. In such a situation, the files within the .CAB file may only be installed if and when the user (or other installer) activates the .CAB file by, for instance, double-clicking on an associated icon within the Windows CE™ operating system.

While such manual activation may not be difficult to perform, more desirable would be an automated installation process. This is particularly the case in situations in which the software is to be installed on, say, hundreds of computing devices, for example if an administrator is installing a program on all of the devices of a particular concern. In addition, if installation could be achieved outside of the operating system, alternative installation mechanisms, such as network-based installation, could be utilized.

### SUMMARY OF THE DISCLOSURE

In one embodiment, a method and system for installing software on a computing device includes determining during booting of the computing device whether a compressed file containing software to be installed has been stored on the computing device and, if so, calling a file installation tool that is configured to open the compressed file and install the contents of the file on the computing device.

### BRIEF DESCRIPTION OF THE DRAWINGS

The disclosed system and method can be better understood with reference to the following drawings. The components in the drawings are not necessarily to scale.

FIG. 1 is a front perspective view of an embodiment of a computing device on which software is to be installed.

FIG. 2 is a rear perspective view of the computing device of FIG. 1.

FIG. 3 is a block diagram of an embodiment of architecture for the computing device of FIGS. 1 and 2.

FIG. 4 is a flow diagram that illustrates an embodiment of a method for installing software on a computing device.

FIGS. 5A and 5B provide a flow diagram that illustrates an embodiment of operation of the software installation manager shown in FIG. 3.

FIG. 6 is a flow diagram that illustrates a further embodiment of a method for installing software on a computing device.

### DETAILED DESCRIPTION

Disclosed is a system and method for installing software. More particularly, disclosed are a system and method for at least partially automating the installation of software contained within a compressed file. In one embodiment, a compressed file that comprises software that is to be installed on a computing device is stored in a predetermined directory of the computing device file system. During the boot process, a software installation manager scans the predetermined directory to determine whether it contains such a compressed file. If so, the software installation manager calls an appropriate installation tool that is configured to open the compressed file and install the software that it contains. Operating in this manner, the software installation manager automates the installation of the various software contained within the compressed file, and permits installation to be performed outside of the computing device operating system.

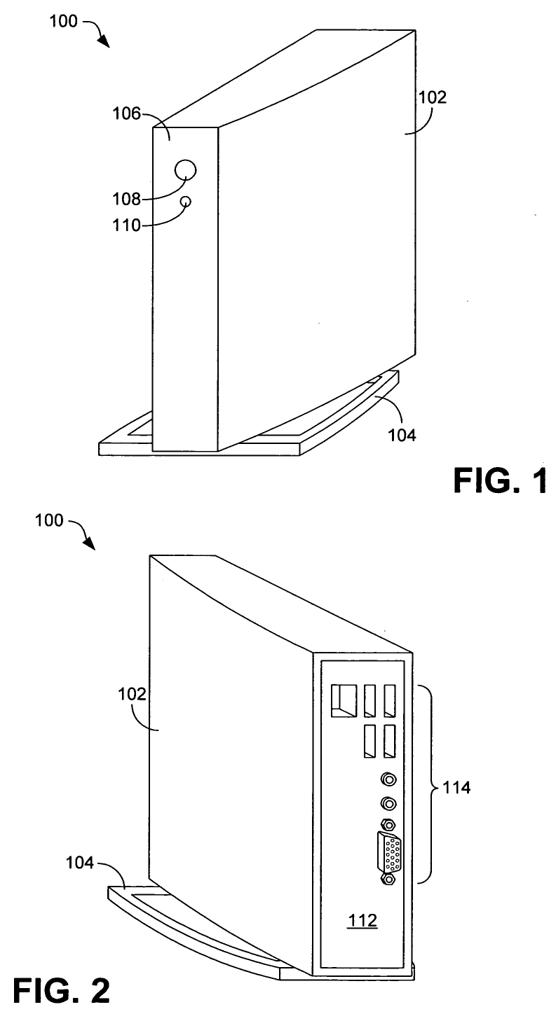

Referring now to the drawings, in which like numerals indicate corresponding parts throughout the several views, FIG. 1 illustrates an example computing device 100 on which software is to be installed. It is noted that, for purposes of this disclosure, the term “software” is used broadly to include both software and firmware, as the case may warrant.

By way of example, the computing device 100 comprises a terminal computer of the type that includes no mass-storage drives such as a hard drive or a compact disc (CD) drive, but may include other nonvolatile memory, such as one or more flash-based devices. In such a case, the computing device 100 may be used as a mechanism or means for accessing other computing devices, such as local or remote servers. Although a terminal computer has been specifically identified as a possible embodiment, the computing device 100 can comprise another computing device on which software that is contained within a compressed file is to be installed. Other examples include handheld computing devices, such as personal digital assistants, mobile telephones, and the like.

As is shown in FIG. 1, the computing device 100 includes a housing 102 that encloses an inner chassis (not visible in FIG. 1) of the computing device. In the example embodiment, the computing device 100 is mounted on a support member 104 that provides stability to the computing device so that it can be placed in an upright position illustrated in FIG. 1. On a front panel 106 of the computing device 100 is a power button 108 and a power indicator 110, such as a light-emitting diode (LED).

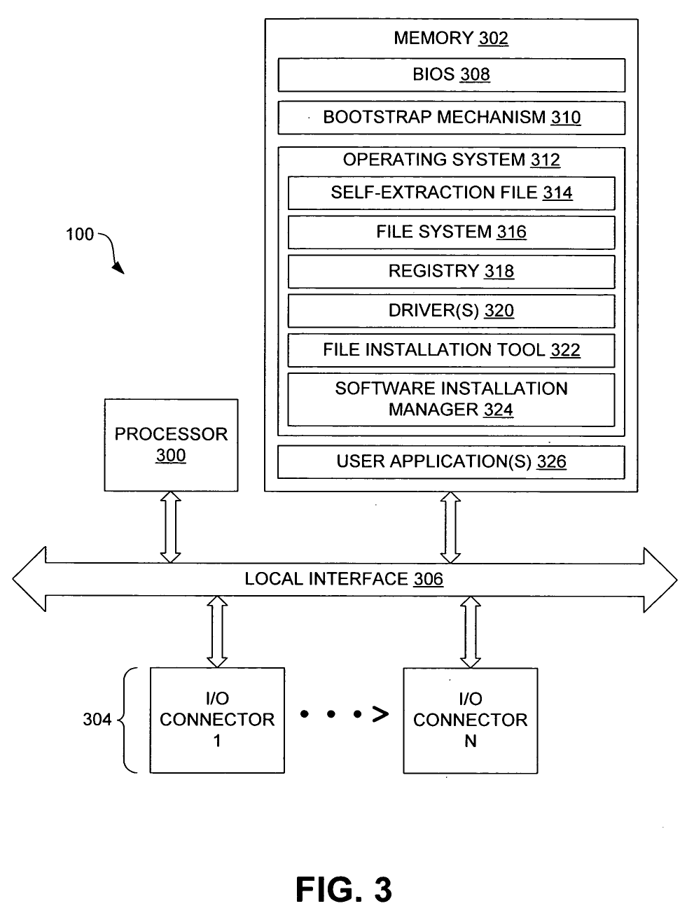

Turning to FIG. 2, which shows the rear of the computing device 100, the computing device further comprises a rear connector panel 112 that comprises a plurality of connectors 114. The connectors 114 are coupled to a motherboard (not visible in FIG. 2) that is, for example mounted to the computing device inner chassis. By way of example, the various connectors 114 include a voice or data telephone jack, universal serial bus (USB) jacks, a microphone jack, a headphone jack, and a parallel port jack. Although those particular connectors have been cited as examples, the connectors 114 may include other types of connectors.

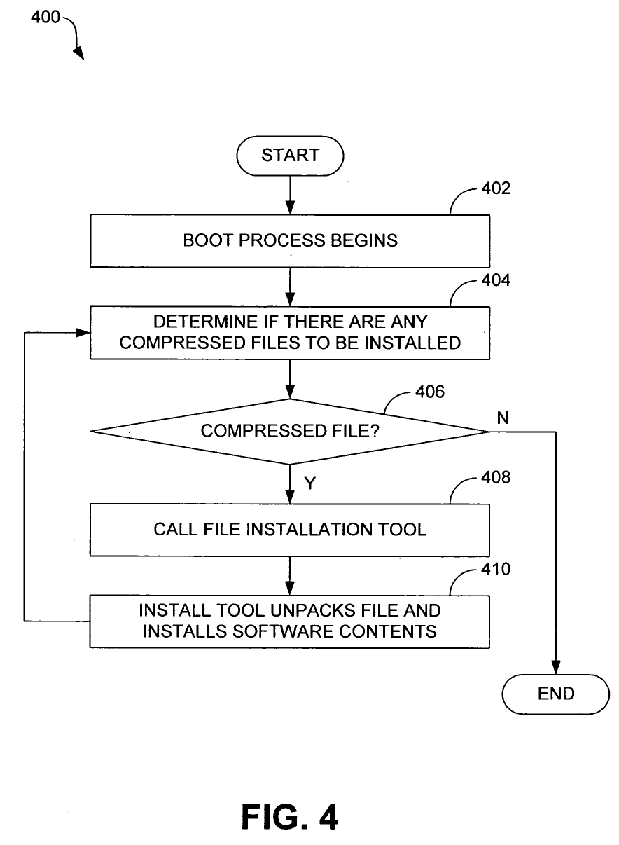

FIG. 3 illustrates an example architecture for the computing device 100 of FIGS. 1 and 2. As is indicated in FIG. 3, the computing device 100 comprises a processor 300 and memory 302, each of which is connected to a local interface 306. Also connected to the local interface 306 are input/output (I/O) connectors 304 (such as connectors 114, FIG. 1).

The computing device processor 300 can include a central processing unit (CPU) or an auxiliary processor among several processors associated with the computing device 100. The memory 302 includes, for example, a combination of one or more volatile memory elements (e.g., random access memory (RAM)) and one or more nonvolatile memory elements (e.g., flash device).

Stored in memory 302 is a basic input-output system (BIOS) 308 that comprises the code that controls low-level operation of the computing device 100 and communications with I/O devices that are connected to the computing device 100 (e.g., keyboard mouse, etc.). The memory 302 further includes a bootstrap mechanism 310 that is called by the BIOS 308 to control the computing device boot process.

Also contained in memory 302 is an operating system 312 that provides scheduling, input-output control, file and data management, memory management, and communication control, and that controls general operation of the computing device 100 from the perspective of the user. As is shown in FIG. 3 the operating system 312 comprises various components (modules and/or files) that the system uses during operation. Those components include a self-extraction file 314 that comprises an image of the operating system and that is used during the initial boot to initialize the operating system and define the environment in which it executes. By way of example, the self-extraction file 314 comprises a NK.bin file of the Windows CE™ operating system.

During the initial boot processes, the bootstrap mechanism 310 reads the self-extraction file 314, copies it to RAM, and execution then jumps to an offset of the image defined by the self-extraction file. When execution transitions to the image within RAM, the operating system 312 self-extracts to define a factory default state by creating a file system 316 and a registry 318, installing various drivers 320, and installing any programs that comprise part of the default state including a file installation tool 322. By way of example, the registry 318 comprises a persistent registry, such as a hive-based registry, which comprises a collection of files that are stored within nonvolatile memory, such as a flash device. The nature of the file installation tool 322 depends upon the nature of the files that it is configured to install. In cases in which the compressed files to be installed are .CAB files, the file installation tool 322 may comprise WCELOAD.EXE from the Microsoft Corporation.

Also included in the operating system 302 is a software installation manager 324. As is described in greater detail below, the software installation manager 324 at least partially automates the installation of software contained in compressed files. In some embodiments, the software installation manager 324 scans certain predetermined directories of the file system 316 to determine if those directories contain compressed files and, if so, calls the file installation tool 322, which is configured to open the compressed files and install their contents. Those contents may comprise user applications 326.

Various programs (i.e., logic) have been described above. It is to be understood that those programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As is described in the foregoing, it may desirable to wrap software to be installed on a computing device within a compressed file. However, certain tools associated with a particular operating system may be required to open that file and install the software it contains if the file is of a proprietary format. In such cases, a user may need to initiate the installation process from the operating system by, for example, double-clicking on an associated icon within the operating system. Given the attendant disadvantages of such manual activation of the installation process within the operating system, it would be beneficial to have a mechanism that at least partially automates the installation process and enables installation outside of the operating system.

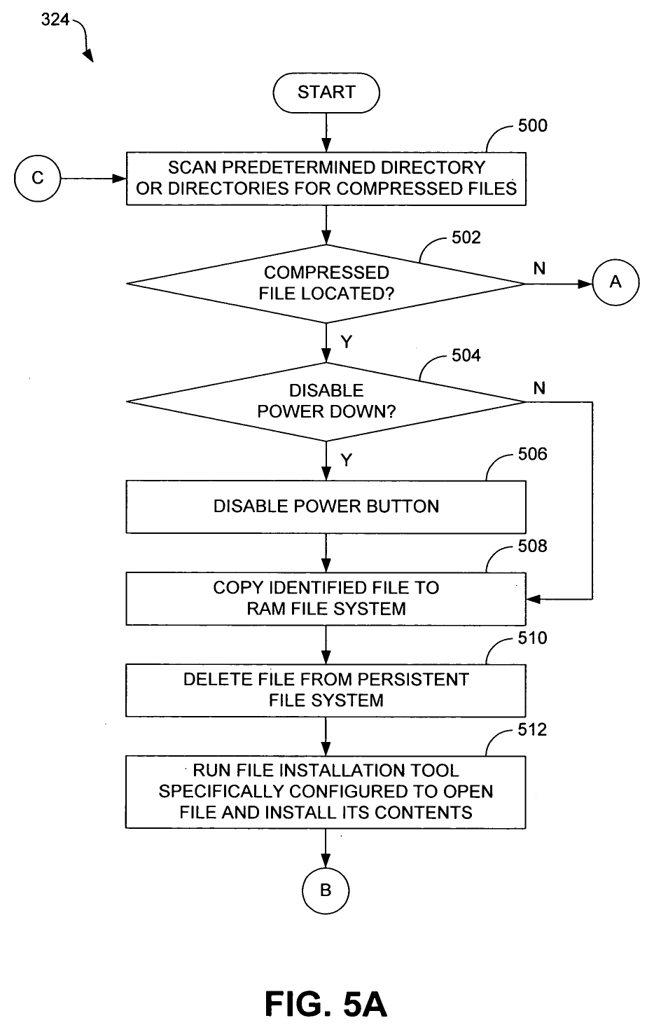

FIG. 4 is a flow diagram that provides an example of a method 400 for installing software on a computing device, such as the device 100 shown in FIGS. 1-3. It is noted that process steps or blocks in the flow diagrams of this disclosure may represent modules, segments, or portions of code that include one or more executable instructions for implementing specific logical functions or steps in the process. Although particular example process steps are described, alternative implementations are feasible. For instance, some steps may be executed out of order from that shown and discussed depending on the functionality involved.

Beginning with block 402 of FIG. 4, the boot process for the computing device at issue begins. During that boot process, it is determined if there are any compressed files to be installed, as indicated in block 404. More particularly, it is determined whether there are any compressed files of the type that comprise software to be installed and for which an installation tool is available.

With reference to decision element 406, if there are no such files, flow for the session (i.e., boot session) is terminated. If, on the other hand, there is such a file, flow continues to block 408 at which the appropriate file installation tool is called. Typically, that tool forms part of the operating system and is specifically configured to act on a particular proprietary compressed file type. Once the file installation tool is called, the tool unpacks the file and installs the software contents of that file, as indicated in block 410. At this point, flow returns to block 404 at which it is determined whether there are any other compressed files to be installed. If so, flow continues in the manner described above until no such files remain and, therefore, all such files have been installed.

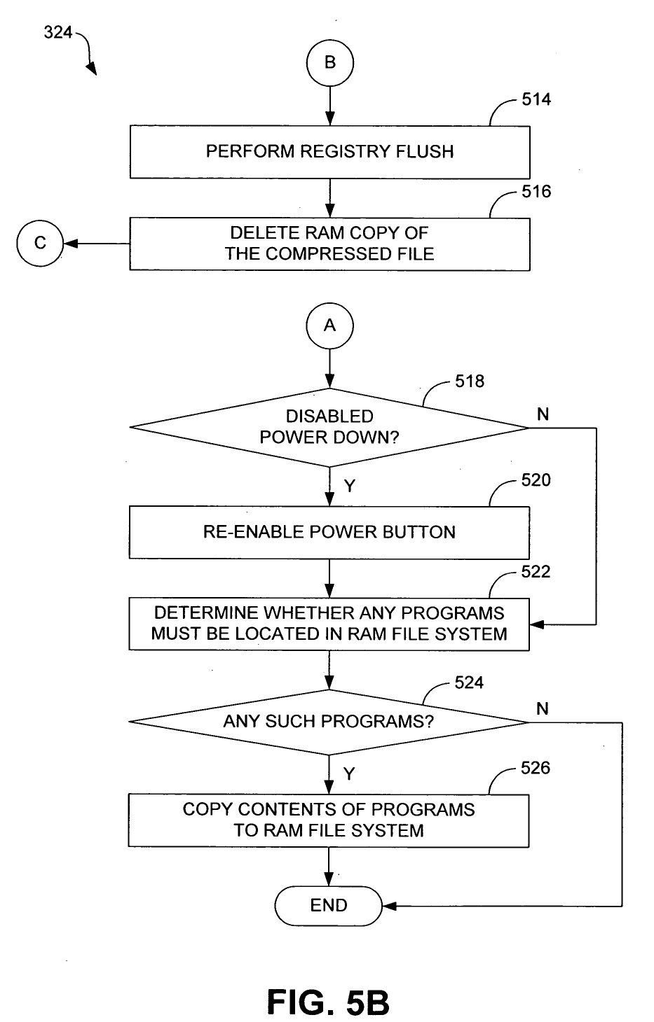

FIGS. 5A and 5B describe an example of operation of the software installation manager 324 shown in FIG. 3. The software installation manager 324 is initiated during the boot process for the computing device, whether that boot is the first performed on the device or a boot performed at some time thereafter. By way of example, the software installation manager 324 is initiated by a system registry entry that is used to dictate when the manger is to be launched during boot.

Once initiated, the software installation manager 324 scans one or more predetermined directories for compressed files of the type that contain software that is to be installed on the computing device, as indicated in block 500. By way of example, the software installation manager 324 scans a “Hard Disk” directory that pertains to a nonvolatile storage device, such as a flash device, as a whole. By way of further example, the compressed files for which the software installation manager 324 scans are .CAB files configured for use on a Windows platform, such as Windows CE™.

With reference to decision element 502, if there are no compressed files in the directory or directories, flow continues on to decision element 518 of FIG. 5B described below. If, however, a compressed file is located, flow continues to decision block 504 at which the software installation manager 324 determines whether to disable power down of the computing device. Such disabling of power down may be advisable given that powering down during writing of data to a nonvolatile storage device, such as a flash device, may result in corruption of the storage device. By way of example, whether power down disabling occurs or not is selectable through a user-adjustable setting.

If power down is not to be disabled, flow continues to decision block 508 described below. If, on the other hand, power down is to be disabled, flow continues to block 506 at which the software installation manager 324 disables the power button of the computing device (e.g., button 108, FIG. 1) so that the user cannot turn off power to the device during writing.

Referring next to block 508, the software installation manager 324 copies the identified compressed file to the RAM file system and, as indicated in block 510, deletes the file from the persistent file system (i.e., stored in nonvolatile memory). In this manner, the software installation manager 324 “moves” the compressed file from nonvolatile to volatile memory and, in so doing, frees space on the nonvolatile storage device (e.g., flash device).

At this point, the software installation manager 324 runs the file installation tool 322 that is specifically configured to open the compressed file and install its contents, as indicated in block 512. In cases in which the compressed file is a .CAB file, the file installation tool 322 may comprise, for example, WCELOAD.EXE. Once run, the file installation tool 322, irrespective of its particular configuration, opens the compressed file and installs the software contained within that file into the locations specified by the compressed file. Such installation may comprise, for instance, the installation of various user applications. In such a case, installation may result in the storage of executable files in the persistent file system and the addition of entries to the operating system registry.

Flow next continues to block 514 of FIG. 5B at which the software installation manager 324 performs a registry flush through which the registry entries of the run-time registry (i.e., RAM-based registry) are copied over to the persistent registry (e.g., hive-based registry), such that all registry modifications (e.g., additions) are preserved in the persistent registry. Notably, this step need not be performed if a separate, persistent registry is not used (e.g., in situations in which the RAM-based registry is preserved with a back-up battery). Assuming that there is a separate, persistent registry, flow then continues to block 516 at which the RAM copy of the compressed file is deleted.

At this point, flow returns to block 500 of FIG. 5A at which the software installation manager 324 again scans the predetermined directory or directories for compressed files. If there are one or more such compressed files remaining, flow continues in the same manner as that described above so that the contents of that or those compressed files are installed. If, on the other hand, no such files remain, flow continues to decision element 518 of FIG. 5B. Flow from that point depends upon whether power down was disabled (decision element 504, FIG. 5A). If not, flow continues to block 522 described below. If so, however, the computing device power button (e.g., button 108, FIG. 1) is re-enabled by the software installation manager 324, as indicated in block 520.

With reference next to block 522, the software installation manager 324 determines whether there are any programs (e.g., .EXE files or .DLL files) that have been installed that must be located in the RAM file system, for example within the “Windows Directory.” This determination is made because some programs are specifically configured for operation within the RAM file system and, therefore, may not function correctly when they are not contained within that file system (e.g., if they only reside in the persistent file system, such as within a “Programs” directory of that persistent file system). Notably, this determination is made for each boot given that the RAM file system is erased each time the computing device is powered down. By way of example, the determination is made by evaluating the path specified for the given program(s). For instance, if the path for a program contains the “RAMCopy” identifier as in:
\Hard Disk\RAMCopy\Program,
   the program can be readily identified as one that is to be copied to the RAM file system.

Referring to decision block 524, if there are no such programs, flow for the software installation session is terminated. If, however, there are one or more such programs, the contents of those programs are copied to the RAM file system, as indicated in block 526.

From the foregoing, it can be appreciated that the software installation manager 324 at least partially automates the installation of software on a computing device by automatically scanning for compressed files that contain software to be installed and automatically running an appropriate file installation tool when such files are discovered. Such functionality removes the need for the user to manually initiate installation of software contained within such a file. Furthermore, such functionality greatly simplifies installation of software on multiple computing devices. For example, if given software is to be installed on many different computing devices at the same time, an administrator can simply download an appropriate compressed file to each of the various computing devices (e.g., using a batch file or a shared directory) so that the software is automatically installed on each device when the devices boot.

In addition, the software installation manager 324 further enables installation of software outside of the operating system, thereby increasing installation options for the user. For example, a user may employ a network-based installation process, such as a pre-boot execution environment (PXE) based installation process, to install the desired software.

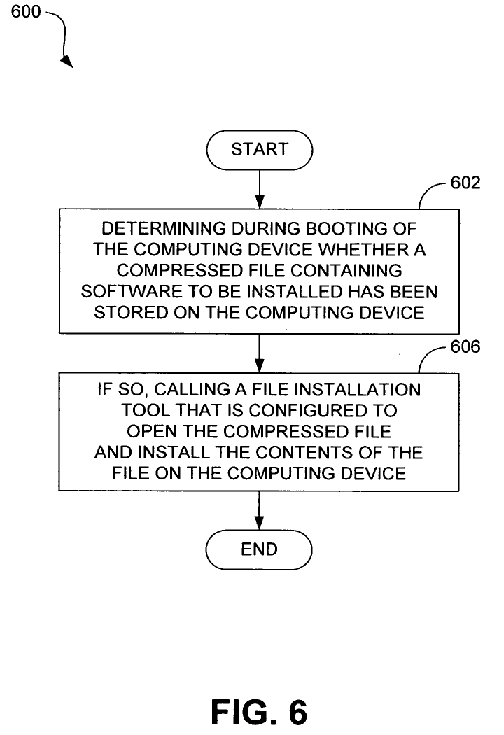

In view of the above, a method 600 for installing software on a computing device can be described as is indicated in FIG. 6. That method comprises determining during booting of the computing device whether a compressed file containing software to be installed has been stored on the computing device (block 602) and, if so, calling a file installation tool that is configured to open the compressed file and install the contents of the file on the computing device (604).

1. A method for installing software on a computing device, the method comprising:
determining during booting of the computing device whether a compressed file containing software to be installed has been stored on the computing device; and
if so, calling a file installation tool that is configured to open the compressed file and install the contents of the file on the computing device.

2. The method of claim 1, wherein determining whether a compressed file containing software to be installed has been stored comprises scanning a directory in the computing device file system.

3. The method of claim 2, wherein scanning a directory comprises scanning the directory for a particular file type.

4. The method of claim 3, wherein scanning the directory for a particular file type comprises scanning the directory for .CAB files.

5. The method of claim 1, wherein calling a file installation tool comprises running an executable that is specifically configured to open the compressed file and install its contents.

6. The method of claim 5, wherein running an executable comprises running WCELOAD.EXE.

7. The method of claim 1, further comprising copying the compressed file to a RAM file system of the computing device and deleting the compressed file from a persistent file system of the computing device.

8. The method of claim 7, further comprising deleting the file copy within the RAM file system after installation of the file contents.

9. The method of claim 1, further comprising performing a registry synchronization between a run-time registry and a persistent registry of the computing device.

10. The method of claim 1, further comprising placing a copy of a program stored in a persistent file system of the computing device in a RAM file system of the computing device if that program is configured for execution within the RAM file system.

11. A system for installing software on a computing device, the system comprising:
means for, during booting, identifying compressed files that contain software to be installed on the computing device; and
means for calling a file installation tool that is configured to open the compressed files and install their contents on the computing device.

12. The system of claim 11, wherein the means for identifying comprise means for scanning a directory in the computing device file system.

13. The system of claim 12, wherein the means for calling a file installation tool comprise means for running an executable that is specifically configured to open the compressed files and install their contents.

14. The system of claim 11, further comprising means for copying the compressed files to a RAM file system, means for deleting the compressed files from a persistent file system, and means for deleting the files copied to the RAM file system.

15. The system of claim 11, further comprising means for performing a registry synchronization between a run-time registry and a persistent registry of the computing device.

16. The system of claim 11, further comprising means for placing a copy of a program installed in a persistent file system of the computing device in a RAM file system of the computing device.

17. A software installation manager stored on a computer-readable medium, the manager comprising:
logic configured to scan a predetermined computing device directory during booting to determine whether the directory includes a compressed file containing software to be installed; and
logic, responsive to scanning results, that is configured to run an executable program that is configured to open compressed files included in the directory and install the contents of the files within a persistent file system of the computing device.

18. The manager of claim 17, wherein the logic configured to scan is configured to scan the predetermined directory for .CAB files.

19. The manager of claim 17, wherein the logic configured to run an executable is configured to run WCELOAD.EXE.

20. The manager of claim 17, further comprising logic configured to copy the compressed files to a RAM file system of the computing device and logic configured to delete the compressed files from a persistent file system of the computing device.

21. The manager of claim 20, further comprising logic configured to delete the copies within the RAM file system after installation of contents of the copies are installed.

22. The manager of claim 17, further comprising logic configured to perform a registry synchronization between a run-time registry and a persistent registry of the computing device.

23. The manager of claim 17, further comprising logic configured to place a copy of a program stored in a persistent file system of the computing device in a RAM file system of the computing device.

24. A computing device, comprising:
a processor; and
memory including a persistent file system and a software installation manager, the installation manager being configured to scan a predetermined computing device directory during booting to determine whether the directory includes a compressed file containing software to be installed, and to run an executable program that is configured to open compressed files included in the directory and install the contents of the files within the persistent file system.

25. The device of claim 24, wherein the software installation manager is configured to scan the predetermined directory for .CAB files.

26. The device of claim 24, wherein the software installation manager is configured to run WCELOAD.EXE.

27. The device of claim 24, wherein the software installation manager is further configured to copy compressed files to a RAM file system, to delete the compressed files from the persistent file system, and to delete file copies within the RAM file system after installation of contents of the file copies are installed.

28. The device of claim 24, wherein the software manager is further configured to perform a registry synchronization between a run-time registry and a persistent registry of the computing device.

29. The device of claim 24, wherein the software manager is further configured to place a copy of a program stored in a persistent file system of the computing device in a RAM file system of the computing device.

30. The device of claim 24, wherein the computing device is a terminal computer that does not comprise a mass-storage drive.
